(19) United States
(12) Patent Application Publication
(10) Pub. No.: US 2007/0215217 A1
(43) Pub. Date: Sep. 20, 2007

(54) Outlet check valve

(76) Inventors: Daniel Goodhope, Joplin, MO (US); Michael E. Gaillard, Joplin, MO (US)

Correspondence Address: WOOD, HERRON & EVANS, LLP, 2700 CAREW TOWER, 441 VINE STREET, CINCINNATI, OH, 45202, US

(21) Appl. No.: 11/376,407

(22) Filed: Mar. 15, 2006

(51) Int. Cl. F16K 15/04

(52) U.S. Cl. 137/512.1; 137/533.11

(57) ABSTRACT

An outlet check valve for use with a high pressure pump and having a retainer with an inlet cavity at one end. A retainer cavity extends between the inlet cavity and an opposite end. The retainer cavity has a volume for receiving a portion of the valve element and a plurality of flow passages that surround the retainer cavity and extend between the inlet cavity and the opposite end. The inlet cavity and the plurality of flow passages conduct a flow of high pressure fluid through the retainer.

### FIELD OF THE INVENTION

This invention relates generally to the field of check valves and, more particularly, to an improved outlet check valve for use with a high pressure waterjet intensifier.

### BACKGROUND OF THE INVENTION

A waterjet intensifier has a high pressure cylinder of, for example, up to 40,000 psi or greater. Fluid to the high pressure cylinder is supplied via an inlet check valve, and pressurized fluid is expelled from the high pressure cylinder through an outlet check valve. In one known example shown in FIG. 4, an outlet check valve 94 is mounted in an outlet fluid passage 96 of a valve body 22. The outlet check valve 94 has an outlet valve ball 120 that seats and seals an opening 122 in one side of a valve seat plate 124. The valve ball 120 further bears against the top of an insert 126 having a diametric slot 128. The slot 128 intersects a center bore 127 that conducts fluid from the outlet fluid passage 96 when the valve ball 120 is pushed away from the seat plate 124. The insert 126 is supported in a center hole 129 extending through a check valve adaptor 130 that is threaded into the check valve body 22. A compression spring 131 is mounted in the center hole 129 below the insert 126 and is effective to bias the valve ball 120 against the valve seat plate 124, thereby biasing the outlet check valve closed.

Thus, the outlet check valve 94 is comprised of a single stationary valve seat plate 124, whereas the valve ball 120, insert 126 and spring 131 all are movable in the operation of the check valve 94. While the outlet check valve 94 functions effectively, after continued use, the spring 131 is subject to failure which usually leads to the replacement of all of the outlet check valve components. Such a servicing process is costly and labor intensive; and therefore, there is a need for an improved outlet check valve that is less expensive and has a longer useful life.

### SUMMARY OF THE INVENTION

The present invention provides an outlet check valve that provides a long, highly reliable service life. In addition, the outlet check valve of the present invention has fewer parts and can be manufactured less expensively than many known outlet check valves. Thus, the outlet check valve of the present invention is especially useful in high pressure cylinders that require a long service life.

These and other objects and advantages of the present invention will become more readily apparent during the following detailed description together with the drawings herein.

### BRIEF DESCRIPTION OF THE DRAWINGS

FIG. 1 is a side elevation view partially in cross-section of a portion of a check valve body illustrating an outlet check valve in accordance with the principles of the present invention.

FIG. 2 is a perspective view of a discharge ball retainer of the outlet check valve of FIG. 1.

FIG. 2A is a cross-sectional view of the discharge ball retainer taken along line 2A-2A of FIG. 2.

FIGS. 3A and 3B are cross-sectional views of the outlet check valve of FIG. 1 in its respective closed and open positions.

FIG. 4 is cross-sectional view of a known outlet check valve.

### DETAILED DESCRIPTION OF THE INVENTION

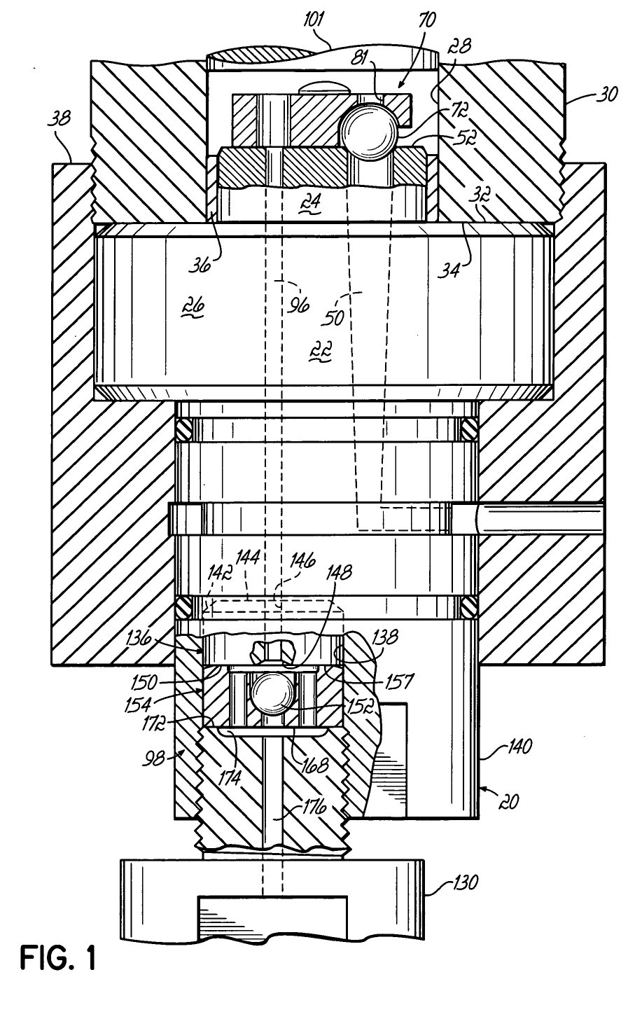

Referring to FIG. 1, a check valve assembly 20 has inlet and outlet check valves 70 and 98, respectively, that are operable to control fluid flows to and from a high pressure cylinder or pump 30. The check valve assembly 20 has a check valve body 22 that, in turn, has a centrally located cylindrical projection 24 at one end that extends beyond a larger diameter flange 26 into the bore 28 of a high pressure hydraulic cylinder or pump 30. The flange 26 has an annular surface 32 that bears against an end surface 34 of the cylinder 30. An annular seal 36 fills the gap between the outer surface of the projection 24 and the inner surface of the bore 28. The check valve body 22 is secured to the end of a high pressure hydraulic cylinder 30 by means of an end cap 38 screwed onto the cylinder 30 in a known manner. An inlet check valve 70 is mounted on the end surface of the projection 24. The inlet check valve 70 includes a valve 72 located above one end of a low pressure fluid inlet passage 50 that is fluidly connected with a source of low pressure fluid (not shown) in a known manner.

An outlet check valve 98 has a valve seat plate 136 located within a bore 138 in an opposite end 140 of the valve body 22. One side of the valve seat plate 136 has an annular beveled or chamfer surface 142 that forms an annular bearing surface 144 around an axial flow path 146. The bearing surface 144 is effective to form a substantially liquid tight seal with the valve body 22, and that seal is formed without the bearing surface 144 being lapped or otherwise specially finished. The flow path 146 intersects, and is contiguous with, the outlet fluid passage 96 and provides a fluid path through the valve seat plate 136. An annular sealing or seating surface 148 is also beveled or chamfered and formed at an intersection of the flow path 146 and an opposite side 150 of the valve seat plate 136. A valve element 152, for example, a valve ball, is successively moved against, and away from, the seating surface 148 to respectively close and open the outlet check valve 98.

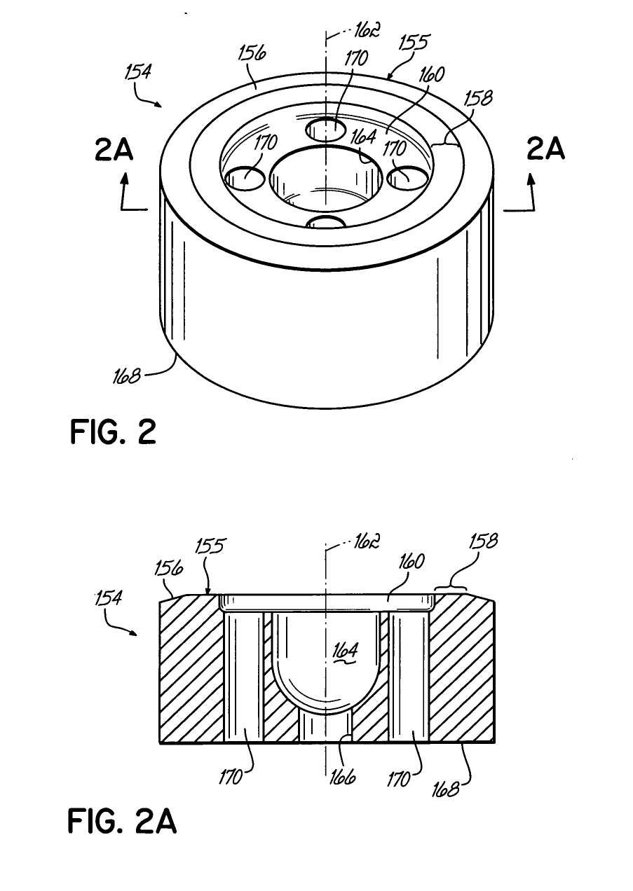

The outlet check valve 98 also has a discharge ball retainer 154 as shown in FIGS. 2 and 2A. One end 155 of the discharge ball retainer 154 has an annular beveled or chamfer surface 156 that forms an annular bearing surface 158, which bears against, and forms a substantially liquid tight seal with, the seat plate surface 157 (FIG. 1). The opposed surfaces 157, 158 are effective to form the seal without being lapped or having another special surface finish. The one end 155 (FIGS. 2 and 2A) of the discharge ball retainer 154 further has an inlet bore or cavity 160 that is generally concentrically positioned with respect to a retainer centerline 162. A valve element or ball retainer cavity 164 extends from the inlet cavity 160 into the ball retainer 154 and has a diameter slightly larger than a diameter of the outlet valve ball 152. A bottom of the retainer cavity 164 intersects one end of a pressure equalization passage 166 that, in turn, intersects an opposite end 168 of the discharge ball retainer 154. The retainer cavity 164 and pressure equalization passage 166 are generally concentrically aligned with respect to the centerline 162. The discharge ball retainer 154 has a plurality of flow paths 170 that extend through the retainer 154 between the inlet cavity 160 and the opposite end 168. Although four flow passages are shown, the number and size of flow passages 170, as well as their relative location with respect to the centerline 162, is variable and can be suitably determined for any particular type and size of cylinder 30.

Referring back to FIG. 1, the check valve adaptor 130 has an end surface 172 that extends into the valve body 22 and has a shallow outlet bore or cavity 174 intersecting a discharge flow passage 176. In an alternative embodiment, the outlet cavity 174 may be formed in the opposite end 168 of the discharge ball adaptor 154.

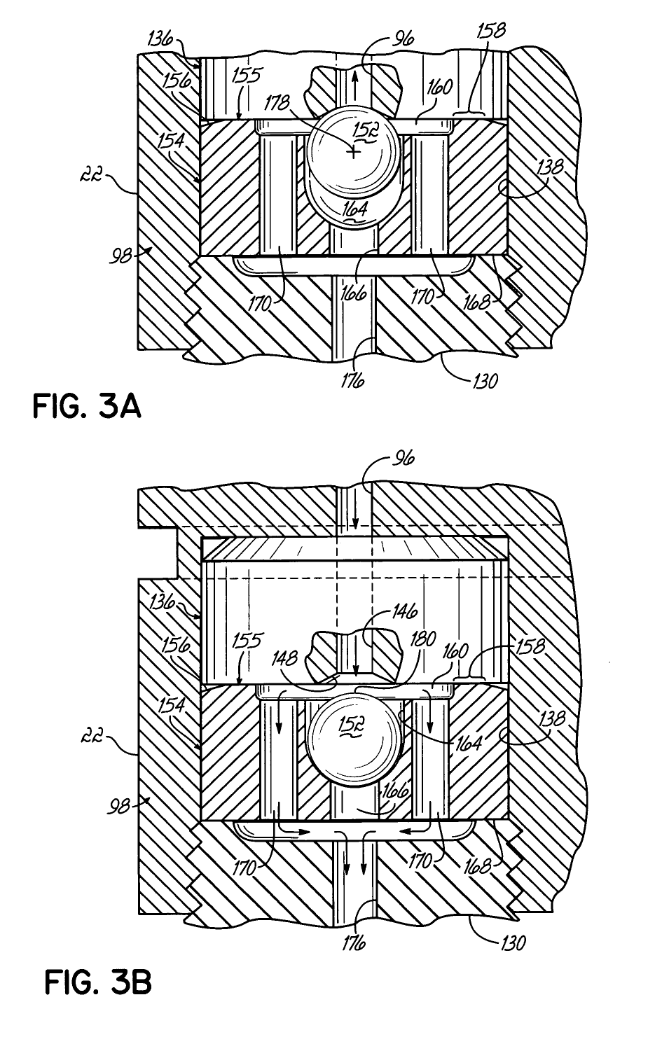

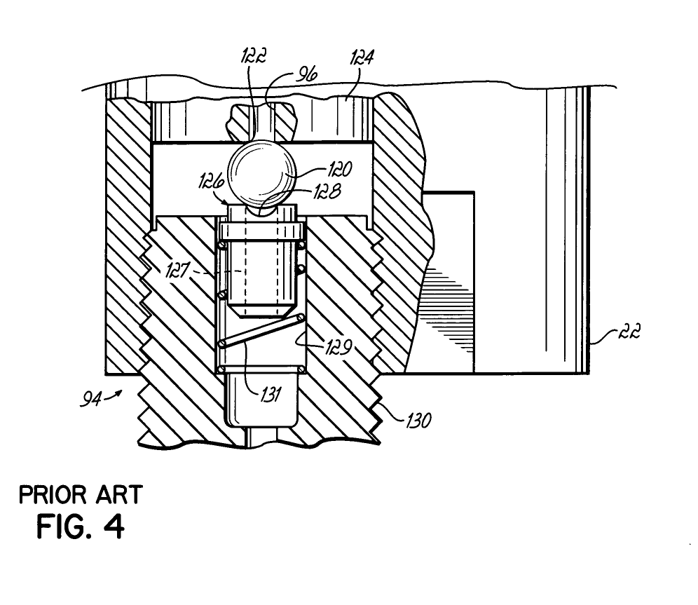

In use, referring to FIG. 1, during an intake stroke, a piston 101 within the cylinder 30 moves away from the projection 24, thereby creating a pressure differential across the inlet check valve 70 such that the fluid in the inlet fluid passage 50 is under a relatively small positive pressure. That positive fluid pressure is applied against the outer surface of the valve 72 and pushes the valve 72 away from the end surface 52 of the projection 24, thereby opening the inlet check valve 70 and allowing fluid to flow from the fluid source (not shown) through the inlet fluid passage 50 and into the bore 28 of the cylinder 30. Motion of the piston 101 away from the projection 24 also causes a pressure differential across the outlet valve ball 152 tending to move it against the seating surface 148 of the seat plate 136 as shown in FIG. 3A. In that process, the pressure equalization passage 166 maintains a common pressure in the cavity 164 below the valve ball 152, the outlet cavity 174 and the flow passages 170. Maintaining colinearity of the centerlines of the outlet flow passage 96 (FIG. 1), flow path 146 (FIG. 3A), valve ball center 178, cavity 164 and passage 166 facilitates obtaining an effective liquid tight seal between the valve ball 152 and the seating surface 148. The effectiveness of the seal is further enhanced by accurately spacing the flow passages 170 with respect to each other as well as a centerline of the flow path 146. In one embodiment, the flow passages 170 are generally equally spaced about the centerline of the flow path 146.

When the piston 101 in the cylinder 30 reverses direction, a very high fluid pressure is applied via the opening 81 to inlet check valve 72, thereby pushing the valve 72 to a closed position and sealing off the fluid inlet passage 50. In addition, the high pressure fluid passes through the fluid passages 96, 146 and pushes the valve ball 152 into the cavity 164 as shown in FIG. 3B, thereby opening the outlet check valve 98. The high pressure fluid then flows through the inlet cavity 160, the flow passages 170, the outlet cavity 174 and out the flow discharge path 176. When the valve ball 152 is in the open position, an upper most point 180 of the valve ball 152 extends above the bearing surface by about 0.024 inch. Further, referring to FIG. 1, the valve ball 152 travels through a distance in a range of about 0.015-0.020 inch to reach the closed position against the seating surface 148.

During the operation of the cylinder pump 30, it is believed that the valve ball 152 continuously rotates, to some extent, to provide a different outer surface area against the annular sealing area around the flow path 146 of the seating plate 136. Therefore, the valve ball 152 wears evenly during use, is less subject to overheating and provides a highly repeatable fill cycle.

The operation of the outlet check valve 98 described herein utilizes only three parts, and only one of those parts, the valve ball 152, is a moving part. Further, the outlet check valve 98 operates effectively without a return spring; and none of its parts require a lapped or other special finish. Thus, the outlet check valve 98 is less expensive to manufacture. With fewer moving parts, the outlet check valve 98 is highly reliable and provides a long service life. A longer service life of the outlet check valve 98 improves the service life of the high pressure cylinder 30, thereby making it more economical to operate. The valve seat plate 136 and discharge ball retainer 154 are made from a hard stainless steel, which also contributes to the long service life of the outlet check valve 98. In alternative embodiments, other suitable materials may be used.

While the invention has been set forth by a description of the preferred embodiment in considerable detail, it is not intended to restrict or in any way limit the claims to such detail. Additional advantages and modifications will readily appear to those who are skilled in the art. For example, in the disclosed embodiment, the outlet valve element 152 is depicted as a valve ball; however, in alternative embodiments, the valve element 152 can be any shape that can be held captured by the retainer cavity 164 and provide a circular line of contact with the seating surface 148 when the valve element is in the closed position. For example, an end of the valve element 152 contacting the seating surface 148 could be conical, hemispherical, elliptical, bullnosed or otherwise curved but not spherical.

In the described embodiment, a seat plate 136 is used because it is a wear part and readily replaceable. However, in an alternative embodiment, the seat plate 136 can be eliminated; and the valve element 152 would seat against and seal an end of the outlet fluid passage 96 in the valve body bore 138.

Therefore, the invention in its broadest aspects is not limited to the specific detail shown and described. Consequently, departures may be made from the details described herein without departing from the spirit and scope of the claims which follow.

What is claimed is:

1. An apparatus for use with a valve element of an outlet check valve in a high pressure pump, the outlet check valve being in fluid communication with an outlet fluid passage of a valve body, the valve body being connectable to the high pressure pump and conducting a high pressure liquid via the outlet fluid passage from the high pressure pump, the apparatus comprising:
a first end;
an opposite end;
an inlet cavity located in the first end;
a retainer cavity extending between the inlet cavity and the opposite end, the retainer cavity comprising a volume adapted to receive a portion of the valve element; and
a plurality of flow passages surrounding the retainer cavity and extending between the inlet cavity and the opposite end, and the inlet cavity and the plurality of flow passages adapted to conduct a flow of high pressure fluid through the retainer.

2. The apparatus of claim 1 wherein the retainer cavity comprises:
a first portion adjacent the first end comprising a first cross-sectional area adapted to receive the valve element; and
a second portion extending between the first portion and the opposite end and comprising a cross-sectional area less than the first cross-sectional area and adapted not to receive the valve element.

3. The apparatus of claim 1 wherein the valve element is substantially spherical, and the retainer cavity comprises:
a first cylindrical portion adjacent the first end comprising a first diameter adapted to receive the valve element; and
a second cylindrical portion extending between the first cylindrical portion and the opposite end and comprising a diameter less than the first diameter and adapted not to receive the valve element.

4. The apparatus of claim 1 further comprising an annular bearing surface on the first end and surrounding the inlet cavity, the annular bearing surface adapted to bear against another surface and form a substantially liquid tight seal.

5. The apparatus of claim 4 further comprising an annular chamfer surface on the first end and surrounding the annular bearing surface.

6. The apparatus of claim 1 wherein the plurality of flow passages are generally equally spaced with respect to each other and the retainer cavity.

7. The apparatus of claim 6 wherein the plurality of flow passages comprises four flow passages.

8. The apparatus of claim 1 wherein the first end and the opposite end comprise opposing ends of a metal plate.

9. The apparatus of claim 5 wherein the metal plate is generally cylindrical.

10. The apparatus of claim 5 wherein the metal plate is stainless steel.

11. An outlet check valve for use with a high pressure pump, the outlet check valve being in fluid communication with an outlet fluid passage of a valve body, the valve body being connectable to the high pressure pump and conducting a high pressure liquid via the outlet fluid passage from the high pressure pump, the outlet check valve comprising:
a seat plate positionable with respect to the valve body and comprising
a flow path extending through the seat plate and adapted to be in fluid communication with the outlet fluid passage, and
a seating surface surrounding one end of the flow path;
a valve element movable between a first position in contact with the seating surface, thereby closing the outlet check valve, and a second position displaced away from the seating surface, thereby opening the outlet check valve; and
a retainer comprising
a first end positionable to contact the seat plate,
an opposite end,
a retainer cavity located in the first end comprising a first diameter for receiving the valve element,
an opening comprising a diameter less than the first diameter and extending between the retainer cavity and the opposite end, and
at least two flow passages surrounding the retainer cavity and extending between the first end and the opposite end, the at least two flow passages being in fluid communication with the seat plate, and the flow path and the at least two flow passages adapted to conduct a flow of high pressure fluid in response to the valve element being in the second position.

12. The apparatus of claim 11 wherein the seat plate further comprises:
one side comprising a first annular bearing surface, the first annular bearing surface adapted to bear against another surface and form a substantially liquid tight seal; and
an opposing side supporting the seating surface.

13. The apparatus of claim 12 wherein the one side of the seat plate further comprises an annular chamfer surface surrounding the first annular bearing surface.

14. The apparatus of claim 11 wherein the valve element is spherical and the retainer cavity is cylindrical.

15. The apparatus of claim 11 wherein the retainer further comprises an inlet cavity in the first end, and respective ends of the retainer cavity and the at least two flow passages intersect the inlet cavity.

16. The apparatus of claim 11 wherein the retainer further comprises:
an annular bearing surface on the first end and surrounding the inlet cavity, the annular bearing surface adapted to bear against another surface and form a substantially liquid tight seal.

17. The apparatus of claim 16 further comprising an annular chamfer surface on the first end and surrounding the annular bearing surface.

18. A check valve apparatus for use with a high pressure pump connected to a source of low pressure fluid, the check valve apparatus comprising:
a valve body;
an inlet fluid passage extending through the valve body and adapted to be connected to the source of low pressure fluid;
an inlet check valve in fluid communication with the inlet fluid passage and adapted to be operable to conduct and block a flow of the low pressure fluid to and from the high pressure pump;
an outlet fluid passage extending through the valve body and adapted to be connected to the high pressure pump;
a flow path in fluid communication with the outlet fluid passage;
an annular seating surface surrounding the flow path;
a valve element movable between a first position in contact with the seating surface, thereby closing the outlet check valve, and a second position displaced away from the seating surface, thereby opening the outlet check valve;
an inlet cavity in fluid communication with the flow path and receiving the valve element;
an outlet cavity downstream of the inlet cavity and adapted to conduct a flow of high pressure fluid from the valve body;
a retainer cavity extending between the inlet cavity and the outlet cavity, the retainer cavity comprising a volume receiving a portion of the valve element; and
a plurality of flow passages surrounding the retainer cavity and extending between the inlet cavity and the outlet cavity, and the inlet cavity, the plurality of flow passages and the outlet cavity adapted to conduct a flow of high pressure fluid through the valve body in response to the outlet check valve being in the second position.

19. The apparatus of claim 18 wherein the valve element is substantially spherical, and the retainer cavity comprises:
a first cylindrical portion adjacent the inlet cavity and comprising a first diameter adapted to receive the valve element; and
a second cylindrical portion extending between the first cylindrical portion and the outlet cavity and comprising a diameter less than the first diameter and adapted not to receive the valve element.

20. The apparatus of claim 18 wherein the plurality of flow passages are substantially equally spaced with respect to each other and the retainer cavity.

21. A high pressure pump connectable to a source of low pressure fluid comprising:
a cylinder;
a piston located in the cylinder operable for reciprocal motion within the cylinder;
a valve body removably mounted on one end of the cylinder;
an inlet fluid passage extending through the valve body and adapted to be connected to the source of low pressure fluid;
an inlet check valve in fluid communication with the inlet fluid passage and operable to conduct and block a flow of low pressure fluid to and from the cylinder;
an outlet fluid passage extending through the valve body and comprising one end in fluid communication with the cylinder, the outlet fluid passage adapted to conduct a flow of high pressure fluid from the cylinder;
a flow path in fluid communication with the outlet fluid passage;
an annular seating surface surrounding the flow path;
a valve element movable between a first position in contact with the seating surface, thereby blocking a flow of high pressure fluid, and a second position displaced away from the seating surface, thereby permitting a flow of high pressure fluid;
a retainer comprising
a first end directed toward the annular seating surface,
an opposing end,
a retainer cavity extending between the first end and the opposite end, the retainer cavity comprising a volume adapted to receive a portion of the valve element; and
a plurality of flow passages surrounding the retainer cavity and extending between the first end and the opposite end, the flow path and the plurality of flow passages adapted to conduct a flow of high pressure fluid in response to the valve element being in the second position.
